(19) United States
(12) Patent Application Publication
(10) Pub. No.: US 2011/0207014 A1
(43) Pub. Date: Aug. 25, 2011

(54) FUEL CELL MEMBRANE ELECTRODE ASSEMBLY AND METHOD FOR PRODUCING THE SAME

(75) Inventors: Naoki MITSUTA, Wako (JP); Taku EGUCHI, Wako (JP)

(73) Assignee: HONDA MOTOR CO., LTD., Tokyo (JP)

(21) Appl. No.: 13/022,573

(22) Filed: Feb. 7, 2011

(30) Foreign Application Priority Data
Feb. 22, 2010 (JP) 2010-035521

(51) Int. Cl. H01M 8/10; H01M 8/00; B05D 5/12

(52) U.S. Cl. 429/480; 429/535; 427/115

(57) ABSTRACT

A fuel cell membrane electrode assembly includes an anode electrode catalyst layer, a cathode electrode catalyst layer, and a polymer electrolyte membrane. A ratio of a pore volume occupied by pores with a pore size of 0.1 μm or less is 70% or more in a pore volume occupied by pores with a pore size of 3 μm or less formed in the anode electrode catalyst layer. The polymer electrolyte membrane is sandwiched between the anode electrode catalyst layer and the cathode electrode catalyst layer.

### CROSS-REFERENCE TO RELATED APPLICATIONS

The present application claims priority under 35 U.S.C. §119 to Japanese Patent Application No. 2010-035521, filed Feb. 22, 2010, entitled “Fuel Cell Membrane Electrode Assembly and Method for Producing the Same.” The contents of this application are incorporated herein by reference in their entirety.

### BACKGROUND OF THE INVENTION

1. Field of the Invention

The present invention relates to a fuel cell membrane electrode assembly (MEA) and a method for producing the same.

2. Description of the Related Art

A known fuel cell membrane electrode assembly includes an anode and a cathode provided on both surfaces of a polymer electrolyte membrane. A fuel cell (single cell) is configured by sandwiching the fuel cell membrane electrode assembly between a pair of separators having flow passages for respective reactive gases (for example, air and hydrogen). In such a fuel cell, electric power is generated by electrochemical reaction between oxygen in the air supplied to the cathode side and hydrogen supplied to the anode side.

However, when electric power generation by the fuel cell is stopped, the supply of the reactive gases to the fuel cell is stopped, but the cathode may be maintained at a high potential due to remaining reactive gases, thereby causing deterioration of the cathode. Therefore, for example, a method of forcing the hydrogen remaining on the anode side to be purged with air is performed.

On the other hand, when the fuel cell is restarted with the air (oxygen) present on the anode side, a corrosion current circuit that corrodes an electrode catalyst layer (carbon) of the cathode is formed. FIG. 7 referred to below is a conceptual view showing a state in which a corrosion current circuit is formed in a fuel cell membrane electrode assembly.

When the fuel cell is restarted, as shown in FIG. 7, oxygen in the air used for purging and represented by O₂ in formula (3) and hydrogen supplied as a reactive gas and represented by H₂ in formula (1) are present on the anode 3 side. On the other hand, on the cathode 4 side, oxygen in the air supplied as a reactive gas and represented by O₂ in formula (2) and water produced as a by-product during power generation and represented by H₂O in formulae (4) and (5) are present. In addition, protons (H⁺) produced in formula (1) move from the anode 3 to the cathode 4 through the polymer electrolyte membrane 2, and a reaction proceeds according to formula (2) to generate electric power.

In this case, a reaction represented by formula (3) proceeds with the oxygen remaining on the anode 3 side. The reaction of formula (3) involves donation of electrons “e⁻” produced in formula (1) and donation of protons (H+) produced by the reaction (decomposition reaction of water on the cathode 4 side) represented by formula (4). In addition, a reaction between water and carbon “C” contained in the electrode catalyst layer, represented by formula (5), proceeds on the cathode 4 side. The electrons “e⁻” produced by proceeding of the reactions represented by formulae (4) and (5) are also donated to the reaction of formula (2). That is, the reactions of formulae (1) to (5) proceed to form a corrosion current circuit between the anode 3 and the cathode 4 as shown in FIG. 7.

For example, assuming that during usual power generation (in the absence of oxygen on the anode 3), the potentials of the anode 3 and the cathode 4 are 0 V and about 0.7 V, respectively, the potentials of the anode 3 and the cathode 4 are about 0.7 V and as high as about 1.4 V, respectively, during restarting in which a corrosion current circuit is formed.

In addition, when the cathode 4 is at such a high potential, the reaction of formula (5) preferentially proceeds rather than the reaction of formula (4) on the cathode 4. As a result, carbon in the electrode catalyst layer (not shown) constituting the cathode 4 is consumed, thereby significantly deteriorating the electrode catalyst layer.

In a conceivable configuration for resolving this problem, for example, the pore size of the electrode catalyst layer of the anode 3 is decreased so as to prevent air (oxygen) from entering the electrode catalyst layer, thereby preventing the reaction represented by formula (3). In further detail, it is considered that the pore size of the electrode catalyst layer is controlled to prevent the entrance of air while allowing the entrance of hydrogen.

As a known technique for controlling the pore size of the electrode catalyst layer, in order to secure a pore volume of the electrode catalyst layer of the cathode 4, the electrode catalyst layer is formed using a composition containing zinc particles (eluted particles) which are eluted with an acid in a subsequent step and two types of carbon particles having different particle size distributions (refer to, for example, Japanese Unexamined Patent Application Publication No. 10-241703).

This technique includes eluting, with an acid, the zinc particles contained in the composition to form pores as elusion marks in the electrode catalyst layer of the cathode 4. Also, as described above, this production method uses the two types of carbon particles including carbon particles with a large particle size (body-forming particles) and carbon particles with a small particle size (catalyst particles) which support a catalyst metal, so that the pore size is not excessively decreased.

However, related art (refer to, for example, Japanese Unexamined Patent Application Publication No. 10-241703) is intended to secure an air circulation by increasing the pore volume of the electrode catalyst layer of the cathode 4. Therefore, the related art is not intended to prevent the entrance of air (oxygen) into the electrode catalyst layer by controlling the pore size to a lower value. Namely, it is impossible for the related art method to form the electrode catalyst layer of the anode 3 which can be prevented from deteriorating when a fuel cell is restarted.

### SUMMARY OF THE INVENTION

According to one aspect of the present invention, a fuel cell membrane electrode assembly includes an anode electrode catalyst layer, a cathode electrode catalyst layer, and a polymer electrolyte membrane. A ratio of a pore volume occupied by pores with a pore size of 0.1 μm or less is 70% or more in a pore volume occupied by pores with a pore size of 3 μm or less formed in the anode electrode catalyst layer. The polymer electrolyte membrane is sandwiched between the anode electrode catalyst layer and the cathode electrode catalyst layer.

According to another aspect of the present invention, a fuel cell membrane electrode assembly includes an anode electrode catalyst layer, a cathode electrode catalyst layer, and a polymer electrolyte membrane. A volume ratio of catalyst particles with a particle size of less than 1 μm contained in the anode electrode catalyst layer is 2.5% or more of a volume of all catalyst particles contained in the anode electrode catalyst layer. The polymer electrolyte membrane is sandwiched between the anode electrode catalyst layers and the cathode electrode catalyst layer.

According to further aspect of the present invention, a method for producing a fuel cell membrane electrode assembly includes mixing at least catalyst particles and an ion conductive material to prepare a composition to form an anode electrode catalyst layer. The composition to form an electrode catalyst layer is applied on a substrate to form an electrode sheet. The electrode sheet is disposed on a surface of a polymer electrolyte membrane to form an anode electrode catalyst layer. The method further includes, before the mixing step, grinding the catalyst particles.

According to further aspect of the present invention, a method for producing a fuel cell membrane electrode assembly includes mixing at least catalyst particles and an ion conductive material to prepare a composition to form an anode electrode catalyst layer. The composition to form an electrode catalyst layer is spread on a substrate to form an electrode sheet. The electrode sheet is disposed on a surface of a polymer electrolyte membrane to form an anode electrode catalyst layer. The method further includes, before the mixing step, adding second catalyst particles to prepared first catalyst particles. The second catalyst particles is produced as undersize catalyst particles by sieving catalyst particles separately prepared, so that a volume ratio of catalyst particles with a particle size of less than 1 μm is 2.5% or more of a volume of all catalyst particles contained in the electrode catalyst layer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic cross-sectional view showing a structure of a proton-exchange membrane fuel cell (single cell) including a fuel cell membrane electrode assembly according to an embodiment of the present invention, in which a separator is show by phantom lines;

FIG. 2 is a graph illustrating a comparison between a pore distribution in an anode electrode catalyst layer of a fuel cell membrane electrode assembly according to an embodiment of the present invention and a pore distribution in an anode electrode catalyst layer of a related art example, in which the pore size (μm) is shown on the abscissa, and the pore volume (μL/mm³) of the electrode catalyst layer is shown on the ordinate;

FIG. 3 is a graph in which a pore size peak position (μm) of a cathode electrode catalyst layer is shown on the abscissa, and a cell voltage (V) of a fuel cell using the electrode catalyst layer is shown on the ordinate;

FIG. 4 is a graph showing a relation between a pore volume ratio of pores with a pore size of 0.1 μm or less to pores with a pore size of 3 μm or less in an electrode catalyst layer of an anode and durability against corrosion (hereinafter, simply referred to as “durability”) of a fuel cell using the electrode catalyst layer, in which the pore volume ratio (%) is shown on the abscissa, and the performance deterioration rate (mV/1000 cycles) of the fuel cell is shown on the ordinate;

FIG. 5 is a graph showing a relation between a pore volume in an electrode catalyst layer of an anode and durability of a fuel cell using the electrode catalyst layer, in which the pore volume (μL/mm³) is shown on the abscissa, and the performance deterioration rate (mV/1000 cycles) of the fuel cell is shown on the ordinate;

FIG. 6 is a graph showing a relation between a volume ratio of catalyst particles with a particle size of less than 0.1 μm used in an anode electrode catalyst layer and durability of a fuel cell using the electrode catalyst layer, in which the volume ratio (%) of catalyst particles with a particle size of less than 0.1 μm is shown on the abscissa, and the performance deterioration rate (mV/1000 times) of the fuel cell is shown on the ordinate; and

FIG. 7 is a conceptual view showing a state in which a corrosion current circuit is formed in a fuel cell membrane electrode assembly.

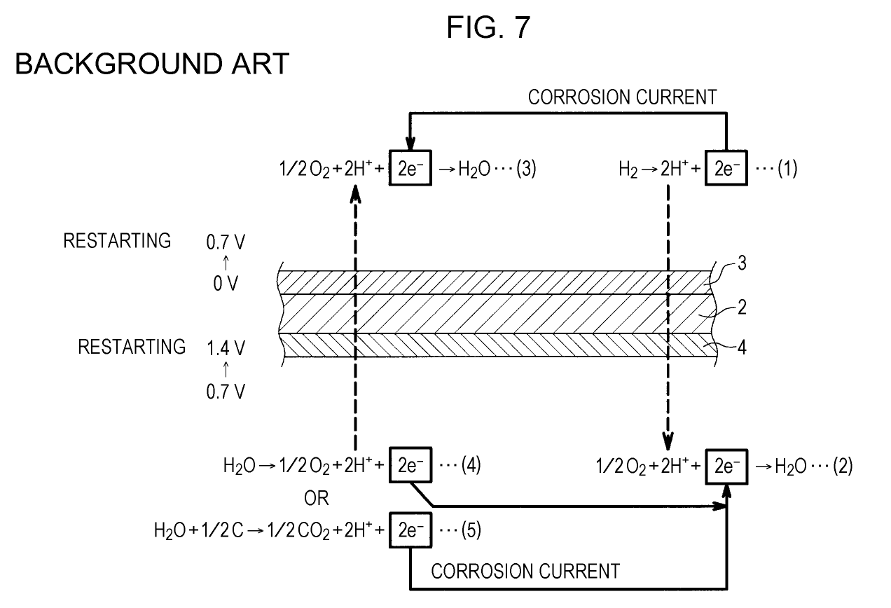

### DESCRIPTION OF THE EMBODIMENTS

A fuel cell membrane electrode assembly according to an embodiment of the present invention is appropriately described in detail below with reference to the drawings, wherein like reference numerals designate corresponding or identical elements throughout the various drawings.

### (Fuel Cell Membrane Electrode Assembly)

As described in detail later, a fuel cell membrane electrode assembly according to an embodiment of the present invention is characterized in that the ratio of pore volume occupied by pores with a pore size of 0.1 μm or less is 70% or more of the pore volume occupied by pores with a pore size of 3 μm or less which are formed in an anode electrode catalyst layer, and also characterized in that the pore volume occupied by pores with a pore size of 3 μm or less which are formed in the anode electrode catalyst layer is 2.0 μL/mm² or less. In the embodiment of the present invention, a pore size is determined by mercury intrusion porosimetry (MIP).

The volume ratio of catalyst particles with a particle size of less than 1 μm contained in the anode electrode catalyst layer is 2.5% or more of the volume of all catalyst particles contained in the anode electrode catalyst layer. The present invention has been achieved based on the finding that an electrode catalyst layer having such the above-described pore volume can be formed using the catalyst particles having such a particle size distribution.

The “catalyst particles” represents carbon particles allowed to support a catalyst metal so as to exhibit catalytic activity. The particle size of the catalyst particles represents the maximum outer diameter of carbon particles that support a catalyst metal.

In addition, the “particle size” represents a so-called effective diameter determined by measurement and analysis of the catalyst particles using a laser diffraction scattering method, a sedimentation method, or the like on the assumption that all the catalyst particles are spherical.

First, an overall configuration of a fuel cell membrane electrode assembly is described.

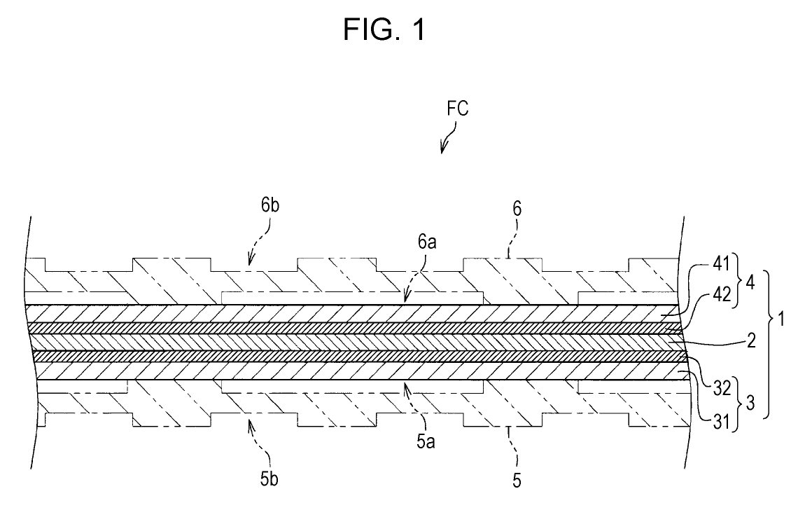

As shown in FIG. 1, a fuel cell membrane electrode assembly 1 includes a polymer electrolyte membrane 2, and an anode 3 and a cathode 4 that sandwich the polymer electrolyte membrane 2 therebetween.

The fuel cell membrane electrode assembly 1 is sandwiched between a pair of separators 5 and 6 to form a proton-exchange membrane fuel cell FC as a single cell. Such single cells are stacked to form a fuel cell stack. In the proton-exchange membrane fuel cell FC as a single cell, when hydrogen which flows through a passage 5a of the separator 5 is supplied to the anode 3, and air that flows through a passage 6a of the separator 6 is supplied to the cathode 4, electric power is generated by an electrochemical reaction between hydrogen and air (oxygen). In addition, the electrochemical reaction is an exothermic reaction, the heat produced by power generation is removed by cooling water that flows through passages 5b and 6b of the respective separators 5 and 6.

The polymer electrolyte membrane 2 constituting the fuel cell membrane electrode assembly 1 (may be simply referred to as the “membrane electrode assembly 1” hereinafter) includes a membrane-shaped solid polymer electrolyte.

Examples of the solid polymer electrolyte include perfluoroalkylenesulfonic acid polymers, perfluoroalkylenephosphonic acid polymers, trifluorostyrenesulfonic acid polymers, ethylene tetrafluoroethylene-g-styrenesulfonic acid polymers, sulfonated polyphenylene sulfide polymers, sulfonated polyimide polymers, phosphoric acid-doped polybenzimidazole polymers, sulfonated syndiotactic polystyrene polymers, sulfonated polyarylene polymers, sulfonated polyether polymers, and the like.

The anode 3 includes a gas diffusion layer 31 and an electrode catalyst layer 32 and is disposed in contact with the polymer electrolyte membrane 2 on the electrode catalyst layer 32 side. The cathode 4 includes a gas diffusion layer 41 and an electrode catalyst layer 42 and is disposed in contact with the polymer electrolyte membrane 2 on the electrode catalyst layer 42 side.

The gas diffusion layers 31 and 41 of the anode 3 and the cathode 4 are adapted for uniformly diffusing hydrogen and air that are supplied through the passages 5a and 6a of the separators 5 and 6 to the contact surfaces with the electrode catalyst layers 32 and 42, respectively. Carbon paper can be used as each of the gas diffusion layers 31 and 41. As the carbon paper, carbon paper including a carbon-Teflon (registered trademark) layer provided on the electrode catalyst layer side can be used.

The electrode catalyst layer 42 of the cathode 4 includes catalyst particles and an ion conductive material. The catalyst particles of the electrode catalyst layer 42 according to this embodiment are carbon particles which support a catalyst metal so as to exhibit catalytic activity in the electrochemical reaction.

As the catalyst metal, a platinum-based catalyst metal can be used, and particularly a catalyst metal composed of a platinum-cobalt alloy is preferably used for the electrode catalyst layer 42 of the cathode 4.

As the carbon particles, particles composed of an electrically conductive material are preferably used, and specific examples of such a material include acetylene black, furnace black (Ketjenblack, Vulcan, and the like), and the like.

In addition, a commercial product can be used as the catalyst particles for the electrode catalyst layer 42.

In this embodiment, the same solid polymer electrolyte as that which forms the polymer electrolyte membrane 2 can be used as the ion conductive material.

Next, the electrode catalyst layer 32 of the anode 3 is described in detail.

The electrode catalyst layer 32 includes catalyst particles and the same ion conductive material as that which can be used for the electrode catalyst layer 42 of the cathode 4.

The catalyst particles of the electrode catalyst layer 32 are carbon particles which support a catalyst metal so as to exhibit catalytic activity in the electrochemical reaction.

As the catalyst metal, like in the electrode catalyst layer 42 of the cathode 4, a platinum-based catalyst metal can be used, and particularly a catalyst metal composed of a platinum-ruthenium alloy is preferably used for the electrode catalyst layer 32 of the anode 3.

As the carbon particles, the same carbon particles as for the electrode catalyst layer 42 of the cathode 4 can be used.

As described above, the catalyst particles of the electrode catalyst layer 32 of the anode 3 contain 2.5% or more of catalyst particles with a particle size of less than 1 μm based on the volume of all catalyst particles contained in the electrode catalyst layer 32.

Although described in detail later, the catalyst particles having such a particle size distribution can be prepared by grinding or classifying catalyst particles which are generally distributed as a commercial product. Classification can be performed by removing catalyst particles having a particle size of 1 μm or more to decrease the volume ratio of the catalyst particles having a particle size of 1 μm or more.

In this embodiment, the electrode catalyst layer 32 is formed using the catalyst particles having the above-described particle size distribution so that a large number of pores with a pore size of 0.1 μm or less can be formed in the electrode catalyst layer 32.

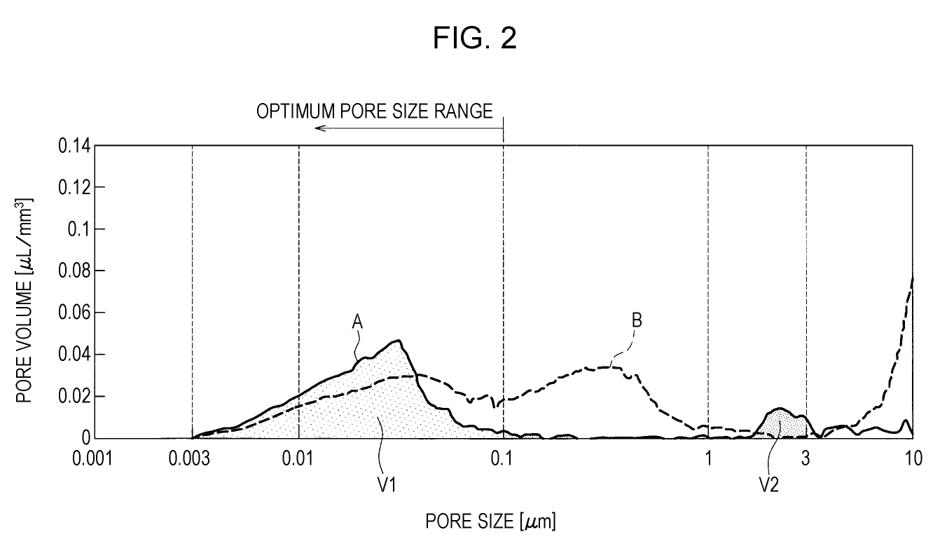

FIG. 2 referred to below is a graph illustrating a comparison between a pore distribution in an anode electrode catalyst layer and a pore distribution in an electrode catalyst layer of a related art example. In FIG. 2, the pore size (μm) is shown on the abscissa, and the pore volume (μL/mm³) of the electrode catalyst layer is shown on the ordinate.

In FIG. 2, “A” denotes a distribution of pore sizes of pores formed in the electrode catalyst layer 32 in the embodiment. The pore volume (V1) occupied by pores with a pore size of 0.1 μm or less is 70% or more of the pore volume (V1+V2) occupied by pores with a pore size of 3 μm or less. The pore volume V2 represents the pore volume occupied by pores with a pore size of over 0.1 μm and 3 μm or less. Namely, for the pores in the electrode catalyst layer 32, the following expression is established.

70≦100·V1/(V1+V2)

Pores specified by the pore volume (V1) have a pore size with which the entrance of air (oxygen) into the electrode catalyst layer 32 is suppressed and include all pores having a pore size of 0.1 μm or less in the electrode catalyst layer 32 measured with a pore size measuring apparatus according to mercury intrusion porosimetry (MIP). A commercial pore size measuring apparatus (for example, Micrometrics' Autopore IV 9520 or the like) according to mercury intrusion porosimetry (MIP) is generally known to have a pore size determination limit of about 0.003 μm. However, in the embodiment of the present invention, a ratio of pores with a pore size with which the entrance of air (oxygen) is suppressed is specified, and thus a lower limit may be determined within a rage of over 0 μm and less than 0.003 μm as long as the pore size is 0.1 μm or less (in an optimum pore size range in FIG. 2). The above-described expression is established for the pore volume (V1) specified within the range of the lower limit or more and 0.1 μm or less.

The pore size of 3 μm is the upper limit of pore size for determining a specific surface area necessary for exhibiting catalytic activity. In addition, pores with a pore size of over 3 μm are generally considered to exponentially decrease the specific surface area of the electrode catalyst layer, thereby causing insufficient catalytic reaction in the electrode catalyst layer. That is, in the embodiment of the present invention, the pore size of over 3 μm which doe not much contribute to the formation of a corrosion current circuit due to the insufficient catalytic reaction is not a specified feature of the invention, and the above problem is resolved by specifying pores with the pore size of 3 μm or less.

According to this embodiment, as described above, in the electrode catalyst layer 32, the pore volume (V1+V2) occupied by pores with a pore size of 3 μm or less is 2.0 μL/mm³ or less per unit volume of the electrode catalyst layer 32. The entrance of air (oxygen) into the electrode catalyst layer 32 having a pore volume (V1+V2) of 2.0 μL/mm³ or less is more securely suppressed.

The pore volume (V1+V2) is preferably 0.3 μL/mm3 or more and 2.0 μL/mm³ or less. The pore volume (V1+V2) of 0.3 μL/mm³ or more facilitates the formation of the electrode catalyst layer 32.

Such a pore distribution of the electrode catalyst layer 32 of the anode 3 can be formed by selecting the catalyst particles so that as described above, the ratio of catalyst particles with a particle size of less than 1 μm is 2.5% or more of the volume of all catalyst particles contained in the electrode catalyst layer 32.

In contrast, in an electrode catalyst layer of related art using catalyst particles which are generally distributed as a commercial product and include less than 2.5% of catalyst particles with a particle size of less than 1 μm, the volume occupied by pores with a pore size of 0.1 μm or less is less than 70% of the pore volume occupied by pores with a pore size of 3 μm or less as shown by curve B in FIG. 2.

Next, the operation and advantage of the membrane electrode assembly 1 according to this embodiment are described.

In the membrane electrode assembly 1 (refer to FIG. 1), the volume ratio of catalyst particles with a particle size of less than 1 μm contained in the electrode catalyst layer 32 of the anode 3 is 2.5% or more of the total volume of all catalyst particles contained in the electrode catalyst layer 32. Therefore, a large number of pores with a pore size of 0.1 μm or less are formed in the electrode catalyst layer 32.

In the membrane electrode assembly 1, therefore, the entrance of air (oxygen) into the electrode catalyst layer 32 of the anode 3 is suppressed. Consequently, in the membrane electrode assembly 1, a corrosion current circuit is prevented from being formed between the anode 3 and the cathode 4 when the fuel cell FC is restarted. Accordingly, the durability of the membrane electrode assembly 1 can be enhanced.

In addition, in the membrane electrode assembly 1 (refer to FIG. 1), the volume ratio of catalyst particles with a particle size of less than 1 μm is 2.5% or more so that a large number of pores within the above-described optimum pore size range can be formed in the electrode catalyst layer 32. Therefore, unlike in related art (refer to, for example, Japanese Unexamined Patent Application Publication No. 10-241703), the process of eluting zinc particles (eluted particles) is not required for controlling the pore volume. Therefore, in the membrane electrode assembly 1, the electrode catalyst layer 32 can be formed by a simplified process, thereby decreasing the production cost.

In addition, in the membrane electrode assembly 1 (refer to FIG. 1), as described above, a large number of pores of 0.1 μm or less are formed in the electrode catalyst layer 32, and specifically, the ratio of pore volume occupied by pores with a pore size of 0.1 μm or less is 70% or more of the pore volume occupied by pores with a pore size of 3 μm or less. Therefore, the entrance of air (oxygen) into the electrode catalyst layer 32 of the anode 3 is suppressed. Consequently, in the membrane electrode assembly 1, a corrosion current circuit is prevented from being formed between the anode 3 and the cathode 4 when the fuel cell FC is restarted. Accordingly, the durability of the membrane electrode assembly 1 can be enhanced.

In addition, in the membrane electrode assembly 1 (refer to FIG. 1), the pore volume occupied by pores with a pore size of 3 μm or less formed in the electrode catalyst layer 32 of the anode 3 is 2.0 μL/mm³ or less. Therefore, the entrance of air (oxygen) into the electrode catalyst layer 32 of the anode 3 is more securely suppressed. Consequently, in the membrane electrode assembly 1, a corrosion current circuit is more securely prevented from being formed between the anode 3 and the cathode 4 when the fuel cell FC is restarted. Accordingly, the durability of the membrane electrode assembly 1 can e more securely enhanced.

### (Method for Producing Membrane Electrode Assembly)

A method for producing the membrane electrode assembly according to the embodiment is described. Here, a method for producing the membrane electrode assembly 1 shown in FIG. 1 is described as an example. The production method of the embodiment of the present invention is characterized by a step of producing the anode 3, while a known production method can be preferably used as a step of producing the cathode 4. Therefore, the step of producing the anode 3 is mainly described below, but a description of the step of producing the cathode 4 is omitted. In the description of the production method below, reference numerals are not shown.

The production method includes a step of preparing a composition for forming an electrode catalyst layer of an anode (first step), a step of forming an electrode sheet using the composition for an electrode catalyst layer (second step), and a step of forming an electrode catalyst layer by disposing the electrode sheet on a surface of a polymer electrolyte membrane.

The method for producing the membrane electrode assembly according to the embodiment is mainly characterized by further including, before the first step, a step of grinding catalyst particles used as a raw material of the composition for forming an electrode catalyst layer of an anode.

In a method for grinding the catalyst particles, the particles can be ground with a grinding tool or device. Examples of the grinding tool or device include various mortars and pestles, a ball mill, a beads mill, a jet mill, and the like.

The grinding allows the catalyst particles to contain a large amount of particles with a particle size of less than 1 μm. Specifically, the volume ratio of catalyst particles with a particle size of less than 1 μm is 2.5% or more. As described above, the particle size is an effective diameter and can be measured by the above-described method.

The particle size distribution of the catalyst particles can be controlled by sieving commercial catalyst particles and collecting undersize particles.

Examples of a sieving method include dry methods such as a sieving method of applying a vibrator to a predetermined mesh, a method using a cyclone classifier based on a high-speed swirling airflow, a method using an elbow-jet classifier, and the like; and wet methods such as a method using a wet classifier based on a difference in settling velocity, a method of centrifuging a dispersion in a solvent, a chromatographic method, and the like. The term “undersize particles” is used for catalyst particles sieved to a finer level by not only a sieving method using a mesh but also other sieving methods.

In the sieving step, the particle size of the catalyst particles is preferably measured under stirring of the catalyst particles without ultrasonic waves in order to simulate a dispersion/aggregation state of actual electrode ink (composition for forming an electrode catalyst layer). This is because the electrode ink is usually applied without ultrasonic waves applied immediately before the ink application.

In measurement of the particle size of the catalyst particles, an aqueous n-propyl alcohol solution (volume ratio to water, 1:1), ethyl alcohol, or the like can be used as a measurement solvent.

In the above-described first step, the catalyst particles subjected to the grinding step and/or the sieving step are mixed with the polymer electrolyte, and if required, further mixed with a solvent, to prepare a paste-like composition for forming an electrode catalyst layer. In the composition for forming an electrode catalyst layer, the mixing ratio of the catalyst particles to the polymer electrolyte can be appropriately determined within a usual range in the field of fuel cells.

Next, in the second step, the composition for forming an electrode catalyst layer is spread on a substrate, for example, a Teflon (registered trademark) sheet or the like, to form an electrode sheet composed of the composition for forming an electrode catalyst layer.

Next, in the third step, the electrode sheet formed in the second step is disposed on a surface of the polymer electrolyte membrane to form an electrode catalyst layer of an anode. In this case, the electrode sheet can be disposed on the polymer electrolyte membrane by transferring the well-dried electrode sheet on the substrate to the polymer electrolyte membrane according to a decal method and then separating the substrate from the electrode sheet.

In the third step, a gas diffusion layer is further formed on the electrode catalyst layer. Then, an electrode catalyst layer and a gas diffusion layer of a cathode are formed by a usual method on the surface of the polymer electrolyte membrane on the side opposite to the anode, resulting in the completion of the membrane electrode assembly of the embodiment of the present invention. The method for forming the gas diffusion layers of the anode and the cathode includes, for example, applying a paste containing polytetrafluoroethylene and carbon black on carbon paper which is separately prepared, drying the paste to form a sheet material, disposing the sheet material on each of the electrode catalyst layers provided on both surfaces of the polymer electrolyte membrane, and then integrating these members by hot pressing.

In the above-described production method, the ratio of particles with a particle size of less than 1 μm is increased by the grinding step and/or the sieving step. As a result, according to the production method, a large number of pores with a pore size of 0.1 μm or less are formed in the electrode catalyst layer of the anode, thereby suppressing the entrance of air (oxygen) into the electrode catalyst layer of the anode. Consequently, in a fuel cell including the membrane electrode assembly produced by the production method, a corrosion current circuit is prevented from being formed between the anode and the cathode when the fuel cell is restarted. Therefore, according to the production method, a membrane electrode assembly with excellent durability can be produced.

In the above-described production method, the ratio of particles with a particle size of less than 1 μm is increased by the grinding step and/or the sieving step. As a result, according to the production method, the volume occupied by pores with a pore size of 3 μm or less formed in the anode electrode catalyst layer can be controlled to 2.0 μL/mm³ or less, preferably 0.3 μL/mm or more and 2.0 μL/mm³ or less. Therefore, according to the production method, the entrance of air (oxygen) into the electrode catalyst layer of the anode is more securely suppressed. Consequently, in the membrane electrode assembly, a corrosion current circuit is prevented from being formed between the anode and the cathode when the fuel cell is restarted. Therefore, according to the production method, a membrane electrode assembly with excellent durability can be more securely produced.

Also, in the above-described production method, the volume ratio of catalyst particles with a particle size of less than 1 μm is 2.5% or more so that a large number of pores within the optimum pore size range can be formed in the electrode catalyst layer. Therefore, unlike in related art (refer to, for example, Japanese Unexamined Patent Application Publication No. 10-241703), the step of eluting zinc particles (eluted particles) is not required for controlling the pore volume. That is, the electrode catalyst layer of the anode can be formed by a simplified process. Therefore, according to the production method, the production cost of the membrane electrode assembly (fuel cell) can be decreased.

In addition, unlike in related art (refer to, for example, Japanese Unexamined Patent Application Publication No. 10-241703), the production method does not require the step of eluting zinc particles (eluted particles) for controlling the pore volume. Therefore, according to the production method, the size (pore size) and volume of pores formed in the electrode catalyst layer are more securely stabilized.

Although the embodiment of the present invention is described above, the present invention is not limited to the embodiment and can be carried out according to various embodiments.

In the above-described embodiment, the composition for forming an electrode catalyst layer of an anode is assumed to contain at least catalyst particles and a polymer electrolyte, but not contain eluted particles such as zinc particles or the like described in Japanese Unexamined Patent Application Publication No. 10-241703. However, the composition for forming an electrode catalyst layer may further contain a pore-forming material such as crystalline carbon fibers or the like. Examples of the crystalline carbon fibers include single-crystal intrinsic whiskers, polycrystalline non-intrinsic whiskers, vapor-grown carbon fibers, carbon nanotubes, and the like.

In addition, the above-described production method includes the grinding step and/or the sieving step so that the electrode catalyst layer of the anode contains a large number of catalyst particles with a particle size of less than 1 μm. However, in the embodiment of the present invention, before the first step, second catalyst particles may be added to the prepared first catalyst particles, the second catalyst particles being produced as undersize catalyst particles by sieving catalyst particles which are separately prepared, so that a volume ratio of catalyst particles with a particle size of less than 1 μm is 2.5% or more of the volume of all catalyst particles contained in the electrode catalyst layer.

According to this production method, an anode electrode catalyst layer which contains a large number of pores of 0.1 μm or less can be formed. Namely, the entrance of air (oxygen) into the electrode catalyst layer of the anode is suppressed. Consequently, in a fuel cell including a fuel cell membrane electrode assembly produced by the production method, a corrosion current circuit is prevented from being formed between the anode and the cathode when the fuel cell is restarted. Therefore, according to the production method, a fuel cell membrane electrode assembly with excellent durability can be produced.

Further, in the embodiment of the present invention, an anode electrode catalyst layer may be formed by selecting, based on measurement, catalyst particles within the above-described particle size distribution range from a plurality of catalyst particle lots, thereby forming a membrane electrode assembly.

### EXAMPLES

Although examples for confirming the advantages of the embodiment of the present invention are described below, the embodiment of the present invention is not limited to these examples.

### (Evaluation Test of Air Permeability of Electrode Catalyst Layer)

In order to confirm that permeation of air (oxygen) is suppressed when the pore size of an electrode catalyst layer is 0.1 μm or less, a confirmatory test was performed using a fuel cell prepared as described below.

### <Formation of Cathode Electrode Sheet for Anode>

Several tens of lots of commercial catalyst particles (trade name “TEC36F52” manufactured by Tanaka Kikinzoku Kogyo, K.K., Pt:Co=3:1 (molar ratio)) were prepared as catalyst particles for a cathode electrode catalyst layer. The catalyst particles include carrier particles composed of acetylene black and a Pt—Co alloy at a mass ratio of 48:52.

Then, seven types of catalyst particles were selected from the several tens of lots of catalyst particles. The selected seven types of catalyst particles are shown by No. S-1 to No. S-7 in Table 1.

TABLE 1

| Catalyst | Pore size peak | Cell potential |
|---|---|---|
| particle No. | position (μm) | (V) |
| S-1 | 0.310 | 0.620 |
| S-2 | 0.210 | 0.610 |
| S-3 | 0.120 | 0.605 |
| S-4 | 0.102 | 0.600 |
| S-5 | 0.097 | 0.555 |
| S-6 | 0.053 | 0.440 |
| S-7 | 0.033 | 0.380 |

Next, the catalyst particles, a solvent (a mixture of n-propyl alcohol and water at a volume ratio of 1:2) in a mass of 10 times the catalyst particles, a perfluoroalkylenesulfonic acid polymer solution (trade name “Nafion (registered trademark) DE2020” manufactured by Dupont, Inc.) were mixed. Then, the resultant mixture was mixed by a planetary ball mill at 80 rpm for 120 minutes to prepare a composition for forming a cathode electrode catalyst layer.

The mount of perfluoroalkylenesulfonic acid polymer solution mixed was determined so that the mass ratio between the catalyst particles and the polymer content in the perfluoroalkylenesulfonic acid polymer solution was 1:1.5.

Next, the composition for forming an electrode catalyst layer was applied to a PET film by screen printing and heated at 60° C. for 10 minutes. Then, the composition for forming an electrode catalyst layer was dried by heating at 100° C. for 15 minutes under reduced pressure to form a cathode electrode sheet on the PET film.

The amount of the composition for forming an electrode catalyst layer applied on the PET film was determined so that the content of the Pt—Co alloy was 0.5 mg/cm².

### <Formation of Anode Electrode Sheet>

Commercial catalyst particles (trade name “TEC10EA50E” manufactured by Tanaka Kikinzoku Kogyo, K.K.) were prepared as catalyst particles for an anode electrode catalyst layer. The catalyst particles included carrier particles composed of graphitized Ketjenblack and Pt at a mass ratio of 50:50.

Next, the catalyst particles, a solvent (a mixture of n-propyl alcohol and water at a volume ratio of 1:1) in a mass of 10 times the catalyst particles, a perfluoroalkylenesulfonic acid polymer solution (trade name “Nafion (registered trademark) DE2020” manufactured by Dupont, Inc.) were mixed. Then, the resultant mixture was kneaded with a planetary ball mill at 80 rpm for 120 minutes to prepare a composition for forming an anode electrode catalyst layer.

The mount of perfluoroalkylenesulfonic acid polymer solution mixed was determined so that the mass ratio between the catalyst particles and the polymer content in the perfluoroalkylenesulfonic acid polymer solution was 1:1.

Next, the composition for forming an electrode catalyst layer was applied to a PET film by screen printing and heated at 60° C. for 10 minutes. Then, the composition for forming an electrode catalyst layer was dried by heating at 100° C. for 15 minutes under reduced pressure to form an anode electrode sheet on the PET film.

The amount of the composition for forming an electrode catalyst layer applied to the PET film was determined so that the content of Pt was 0.3 mg/cm².

### <Formation of Sheet Material for Gas Diffusion Layer>

First, carbon black (trade name “Ketjenblack EC” manufactured by Mitsubishi Chemical Corporation) and polytetrafluoroethylene particles (trade name “Teflon (registered trademark) 640J” manufactured by Mitsui-DuPont Fluorochemical Co., Ltd.) were mixed at a mass ratio of 4:6 to prepare a mixture. The mixture was dispersed in ethylene glycol to prepare a slurry-like composition for forming a gas diffusion layer.

Next, the composition for forming a gas diffusion layer was applied to one (flat surface side) of the surfaces of carbon paper (trade name “TGP-H060” manufactured by Toray Industries, Inc.) and then dried to form a sheet material including the carbon paper and an underlying layer composed of the composition for forming a gas diffusion layer.

### <Production of Membrane Electrode Assembly>

The cathode electrode sheet formed on the PET film and the anode electrode sheet formed on the PET film were disposed on both surfaces of a prepared polymer electrolyte membrane (trade name “Nafion (registered trademark) N112” manufactured by Dupont, Inc.) and then integrated together by hot pressing at 120° C. and 2.0 MPa. Then, the PET films were respectively separated from a pair of electrode sheets which sandwiched the polymer electrolyte membrane therebetween to form an assembly (CCM: Catalyst Coated Membrane) including electrode catalyst layers formed on the polymer electrolyte membrane. That is, seven assemblies (CCM) were formed according to the selected types of catalyst particles.

Then, each of the assemblies (CCM) was sandwiched between the underlying layers of a pair of sheet materials for gas diffusion layers and heated and pressed by hot pressing at 150° C. and 2.5 MPa for 12 minutes to produce a membrane electrode assembly.

### <Test of Power Generation Performance of Fuel Cell>

A fuel cell (JARI (Japan Automobile Research Institute) standard cell) was formed for each of the formed membrane electrode assemblies, and the cell potential (V) of each of the formed fuel cells was measured. The results are shown in Table 1. As operation conditions of the fuel cells, the utilization rate of pure hydrogen and air was 75%, the humidity of the anode and cathode was 70% (relative humidity), and the gas pressures of both the anode and the cathode were 100 kPa.

### <Measurement of Pore Size Peak Position in Electrode Catalyst Layer of Cathode>

The pore size peak position in the cathode electrode catalyst layer was measured for the membrane electrode assemblies sampled in the production process. Specifically, the anode electrode catalyst layer was removed from each of the membrane electrode assemblies, and the pore size peak position was measured for the cathode electrode catalyst layer bonded to the polymer electrolyte membrane.

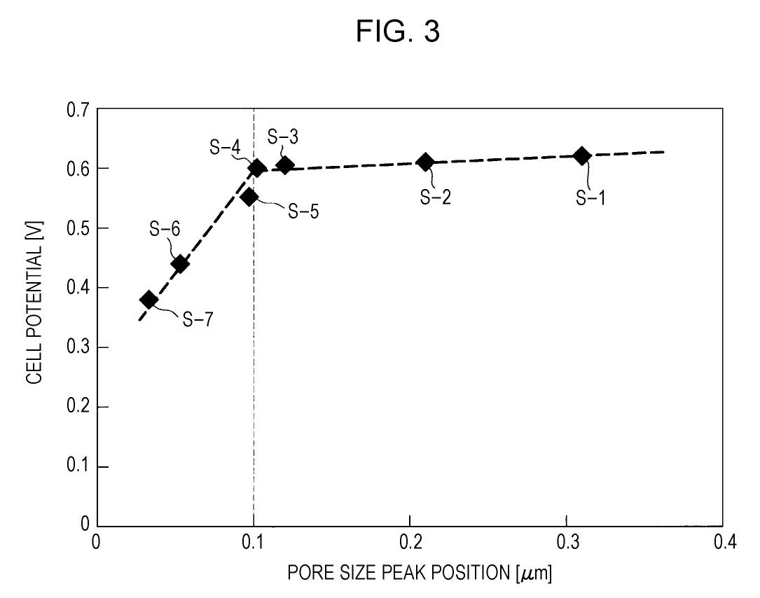

The pore size peak position was measured using a mercury porosimeter (trade name “Autopore IV” manufactured by Micrometrics, Inc.). The results are shown in Table 1 and FIG. 3. FIG. 3 is a graph in which the pore size peak position (μm) of the cathode electrode catalyst layer is shown on the abscissa, and the cell voltage (V) of the fuel cell using the electrode catalyst layer is shown on the ordinate. In FIG. 3, the catalyst particle Nos. used for the electrode catalyst layers are added to the respective plots shown in the graph.

### <Evaluation Results of Air Permeability of Electrode Catalyst Layer>

FIG. 3 indicates that the fuel cell using the cathode electrode catalyst layer having a pore size peak position at over 0.1 μm shows a stable cell voltage of about 0.6 V, while a fuel cell using a cathode electrode catalyst layer having a pore size peak position at 0.1 μm or less shows rapid decrease in cell voltage at a value of 0.1 μm as a boundary.

That is, it is considered that permeation of air (oxygen) in an electrode catalyst layer is suppressed by pores with a pore size of 0.1 μm or less.

### (Confirmatory Test for Principle of the Invention)

It was confirmed that a predetermined correlation is present between the ratio of pore volume occupied by pores with a pore size of 0.1 μm or less to pores with a pore size of 3 μm or less in an anode electrode catalyst layer and the durability of a membrane electrode assembly.

### <Formation of Cathode Electrode Sheet>

A cathode electrode sheet was formed by the same method as described above using catalyst particle No. S-1 (see Table 1) as catalyst particles for a cathode electrode catalyst layer.

### <Formation of Anode Electrode Sheet>

The same tens of lots of commercial catalyst particles (trade name “TEC10EA50E” manufactured by Tanaka Kikinzoku Kogyo, K.K.) as described above for the anode electrode catalyst layer were separately prepared.

Then, the particle size distribution of each of the lots of catalyst particles was measured. The measurement was performed using a laser diffraction particle size distribution measuring device (SALD-2000 manufactured by Shimadzu Corporation).

As a measurement solvent, a mixture of n-propyl alcohol and water at a volume ratio of 1:1 was used. The particle size distribution was measured by adding catalyst particles of a sample in the mixture under stirring. After stirring for 20 minutes, the measurement was started. During the measurement, stirring was continued. During the measurement, the absorbance was set to 0.17 to 0.19, and the mixture containing the sample was maintained at a temperature of 23° C. In addition, the measurement was performed without ultrasonic waves applied to the sample in order to reproduce a catalytic condition during coating.

The particle size distribution of catalyst particles was also measured using a mixture of n-propyl alcohol and water at a volume ratio of 1:1. In this case, the same results as in the use of the mixture at a volume ratio of 1:2 were obtained.

Then, seven types of catalyst particles having different particle size distributions were selected from the several tens of lots of catalyst particles. The selected seven types of catalyst particles are shown by No. NG-1 to No. NG-3 and No. G-1 to No. G-4 in Table 2.

TABLE 2

| | Ratio of pore volume | |
|---|---|---|
| | occupied by pores | Performance |
| | with pore size of 0.1 μm | deterioration |
| | or less in | rate of fuel |
| Catalyst | electrode catalyst | cell (mV/1000 |
| particle No. | layer (%) | cycles) |
| NG-1 | 25 | 73 |
| NG-2 | 47 | 52 |
| NG-3 | 65 | 27 |
| G-1 | 72 | 20 |
| G-2 | 81 | 19 |
| G-3 | 89 | 18 |
| G-4 | 80 | 20 |

Next, seven anode electrode sheets were formed on respective PET films by the same method as described above except that the catalyst particles shown in Table 2 were used.

### <Production of Membrane Electrode Assembly>

A membrane electrode assembly was formed by the same method as described above except that the prepared cathode electrode sheet and each of the seven anode electrode sheets were used.

### <Durability Test of Membrane Electrode Assembly>

A fuel cell (JARI (Japan Automobile Research Institute) standard cell) was formed for each of the formed membrane electrode assemblies. Each of the fuel cells was started and stopped repeatedly 5000 times at a cell temperature set to 50° C. During starting, pure hydrogen was supplied to the anode side, and the air was supplied to the cathode side. The anode humidity and cathode humidity were both RH 100%. During stopping, both the anode and cathode electrode sides were replaced with nitrogen and further replaced with the air.

In the durability test, the cell potential was measured after each 500 cycles of starting and stopping. The cell potential was measured at a cell temperature set to 70° C., an anode humidity of 65%, a cathode humidity of 75%, and pure hydrogen and air pressures both set to 100 kPa. In addition, the cell potential was measured under a condition of 1 A/cm². A decrease in cell potential per 1000 cycles was calculated by linear approximation based on the measurement values of the cell potential. The calculated performance deterioration rate (mV/1000 cycles) is shown as an index for durability of the membrane electrode assembly in Table 2.

### <Measurement of Pore Volume in Anode Electrode Catalyst Layer>

The pore volume in the anode electrode catalyst layer was measured for the membrane electrode assemblies sampled during the production process. Specifically, the cathode electrode catalyst layer was removed from each of the membrane electrode assemblies, and the pore volume was measured for the anode electrode catalyst layer bonded to the polymer electrolyte membrane.

The pore volume was measured using a mercury porosimeter (trade name “Auto Pore 4” manufactured by Micrometrics, Inc.).

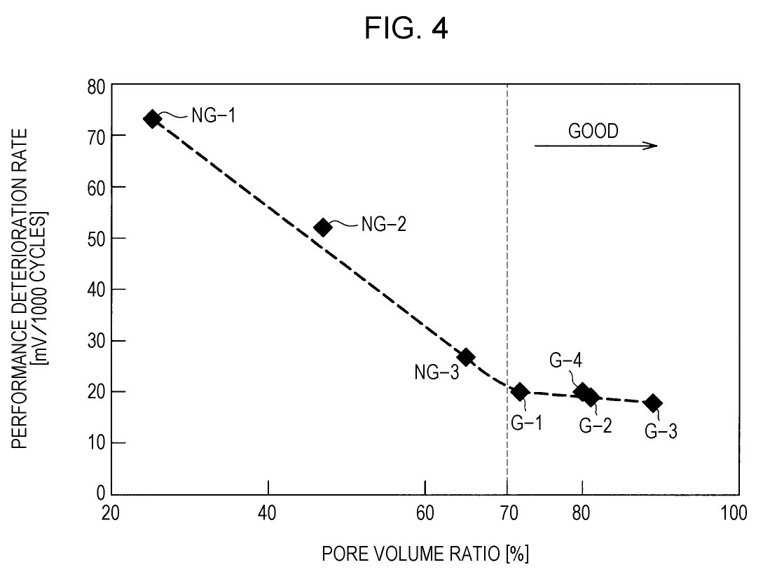

In this measurement, a pore volume (V1 in FIG. 2) occupied by pores with a pore size of 0.003 μm (determination limit of the mercury porosimeter) or more and 0.1 μm or less and a pore volume (V2 in FIG. 2) occupied by pores with a pore size of over 0.1 μm and 3 μm or less were measured. In addition, a ratio of the pore volume occupied by pores with a pore size of 0.1 μm or less in the pore volume occupied by pores with a pore size of 0.003 μm or more and 3 μm or less was calculated. The results are shown as “Ratio (%) of pore volume” in Table 2 and also shown in FIG. 4. In FIG. 4, the pore volume ratio (%) is shown on the abscissa, and the performance deterioration rate (mV/1000 cycles) of the fuel cell is shown on the ordinate. Also, the catalyst particles Nos. used for fuel cells are added to the respective plots shown in FIG. 4.

### <Relation Between Pore Volume Ratio and Performance Deterioration Rate>

FIG. 4 indicates that the performance deterioration rate (mV/1000 cycles) decreases as the ratio (%) of pore volume occupied by pores with a pore size of 0.1 μm or less increases. Specifically, the performance deterioration rate (mV/1000 cycles) of the fuel cell substantially linearly decreases in the order of catalyst particle No. NG-1, No. NG-2, and NG-3. When the ratio (%) of pore volume becomes 70%, an inflection point occurs, and when the ratio (%) of pore volume is 70% or more, the performance deterioration rate (mV/1000 cycles) is made stable at low values as shown by No. G-1, No. G-2, No. G-3, and No. G-4 in FIG. 4.

These results confirmed that when a fuel cell includes an anode electrode catalyst layer in which the pore volume (V1 in FIG. 2) occupied by pores with a pore size of 0.1 μm or less is 70% or more of the pore volume (V1+V2 in FIG. 2) occupied by pores with a pore size of 3 μm or less, specifically, the determination limit of 0.003 μm or more and 3 μm or less, the performance deterioration rate (mV/1000 cycles) is stably decreased. That is, it was confirmed that the durability of the anode electrode catalyst layer is further improved.

### <Relation Between Pore Volume and Durability of Membrane Electrode Assembly>

Next, it was confirmed that a predetermined correlation is present between the pore volume occupied by pores with a pore size of 3 μm or less in an anode electrode catalyst layer and durability of a membrane electrode assembly.

Apart from the above-described seven types of catalyst particles, four types of catalyst particles having different particle size distributions were selected from the several tens of lots of catalyst particles (trade name “TEC10EA50E” manufactured by Tanaka Kikinzoku Kogyo K.K.). The selected four types of catalyst particles are shown by No. NG-4, No. NG-5, No. NG-6, and No. G-5 in Table 3.

In Table 3, Nos. G-1 to G-4 are the same as shown in Table 2.

TABLE 3

| | Pore volume occupied | Performance |
|---|---|---|
| | by pores with pore | deterioration |
| | size of 3 μm or less | rate of fuel |
| Catalyst | in electrode catalyst | cell (mV/1000 |
| particle No. | layer (μL/mm³) | cycles) |
| NG-4 | 3.7 | 34 |
| NG-5 | 3.1 | 32 |
| NG-6 | 2.4 | 27 |
| G-1 | 1.5 | 20 |
| G-2 | 0.8 | 19 |
| G-3 | 0.3 | 18 |
| G-4 | 2 | 20 |
| G-5 | 1.4 | 18.5 |
| G-6 | 0.9 | 18 |
| G-7 | 0.3 | 19 |

Catalyst particle No. G-6 shown in Table 3 was prepared by grinding catalyst particle No. NG-3 shown in Table 2. Specifically, catalyst particle No. G-6 was prepared by crushing 2 g each of fractions of catalyst particle No. NG-3 with an agate mortar for 20 minutes and gathering the crushed fractions.

Catalyst particle No. G-7 shown in Table 3 was prepared by sieving catalyst particles of any desired lot selected from several tens of lots of catalyst particles (trade name “TEC10EA50E” manufactured by Tanaka Kikinzoku Kogyo K.K.) and adding the catalyst particles (corresponding to the above-described second catalyst particles as undersize particles) sieved to a finer particle level to catalyst particle No. NG-3 (corresponding to the above-described first catalyst particles) shown in Table 2. Undersize catalyst particles with a particle size of 2 μm or less were obtained by sieving with a cyclone classifier (trade name “Model MP-150” manufactured by Nippon Pneumatic Industries Ltd.). That is, catalyst particle No. G-7 shown in Table 3 was prepared by adding the undersize catalyst particles in an amount of 30% of catalyst particle No. NG-3 shown in Table 2.

Next, the particle size distribution of each of catalyst particle Nos. NG-4 to NG-6 and Nos. G-4 to G-7 was measured under the same conditions as described above. The volume ratio of catalyst particles with a particle size of less than 1 μm is shown in Table 4.

TABLE 4

| | Volume ratio of | Performance |
|---|---|---|
| | catalyst | deterioration |
| | particles with | rate of fuel |
| Catalyst | particle size of | cell (mV/1000 |
| particle No. | 1 μm or less (%) | cycles) |
| NG-4 | 1.5 | 34 |
| NG-5 | 1.8 | 32 |
| NG-6 | 2.2 | 27 |
| G-4 | 2.5 | 20 |
| G-5 | 11 | 18.5 |
| G-6 | 18 | 18 |
| G-7 | 23 | 19 |

Then, anode electrode catalyst layers were formed by the same method as described above except that the six types of catalyst particles, i.e., catalyst particle Nos. NG-4 to NG-6 and G-5 to G-7 were used, thereby forming six types of membrane electrode assemblies.

The same durability test as described above was performed for each of the formed membrane electrode assemblies. The results are shown in Tables 3 and 4. In Table 3, the values of “Performance deterioration rate of fuel cell (mV/1000 cycles)” of catalyst particle Nos. G-1, G-2, G-3, and G-4 (refer to Tale 2) are transcribed. In Table 4, the value of “Performance deterioration rate of fuel cell (mV/1000 cycles)” of catalyst particle No. G-4 (refer to Tale 2) is transcribed.

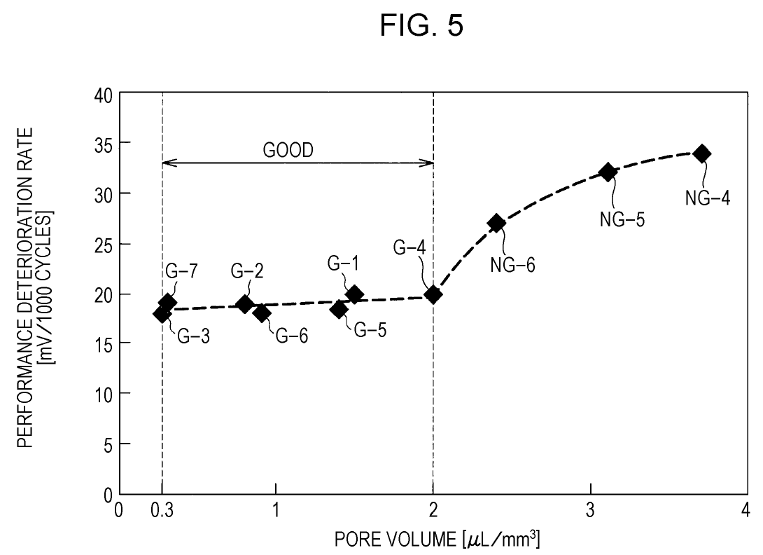

FIG. 5 shows a relation between “Pore volume (μL/mm³) occupied by pores with pore size of 3 μm or less” and “Performance deterioration rate of fuel cell (mV/1000 cycles)” shown for catalyst particle Nos. NG-4 to NG-6 and G-1 to G-7 in Table 3. In FIG. 5, the pore volume (μL/mm³) is shown on the abscissa, and the performance deterioration rate (mV/1000 cycles) of the fuel cell is shown on the ordinate. In addition, the catalyst particles Nos. used in the fuel cells are added to the respective plots shown in FIG. 5.

FIG. 5 indicates that the performance deterioration rate (mV/1000 cycles) decreases as the pore volume (μL/mm³) occupied by pores with a pore size of 0.003 μm or more and 3 μm or less decreases. Specifically, the performance deterioration rate (mV/1000 cycles) of the fuel cell decreases in the order of catalyst particle No. NG-4, No. NG-5, and NG-6. When the pore volume is 2 μL/mm³ or less, an inflection point occurs, and the performance deterioration rate (mV/1000 cycles) is made stable at a low value between pore volumes of 0.3 μL/mm³ and 2 μL/mm³.

These results confirmed that when a fuel cell includes an anode electrode catalyst layer in which the pore volume occupied by pores with a pore size of 3 μm or less is 2 μL/mm³ or more, the performance deterioration rate (mV/1000 cycles) is stably decreased. That is, it was confirmed that the durability of the anode electrode catalyst layer is further improved.

### <Relation Between Particle Size Distribution of Catalyst Particles and Durability of Membrane Electrode Assembly>

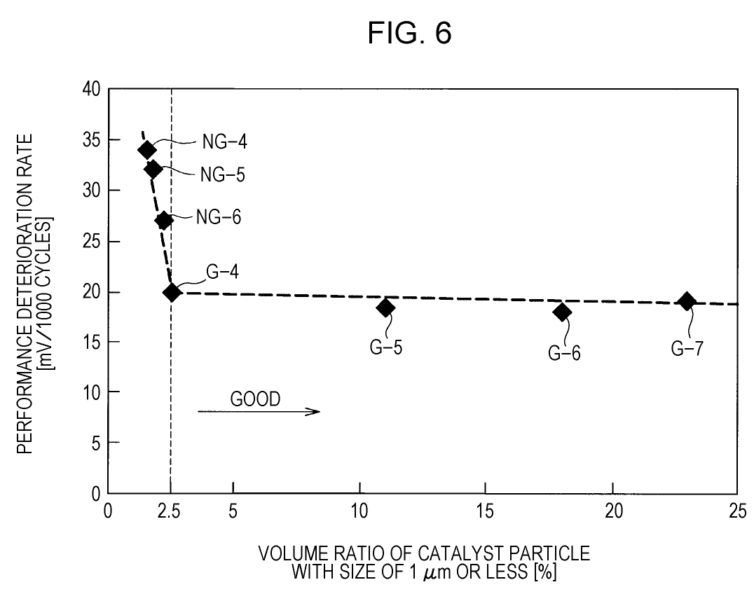

FIG. 6 shows a relation between “Volume ratio (%) of catalyst particles with particle size of less than 0.1 μm” shown for catalyst particle Nos. NG-4 to NG-6 and G-4 to G-7 in Table 4 and “Performance deterioration rate (mV/1000 cycles) of fuel cell”. In FIG. 6, the volume ratio (%) of catalyst particles with a particle size of less than 0.1 μm is shown on the abscissa, and the performance deterioration rate (mV/1000 cycles) of the fuel cell is shown on the ordinate.

FIG. 6 indicates that the performance deterioration rate (mV/1000 cycles) decreases as the volume ratio (%) of catalyst particles with a particle size of less than 1 μm increases. Specifically, the performance deterioration rate (mV/1000 cycles) of the fuel cell substantially linearly decreases in the order of catalyst particle No. NG-4, No. NG-5, and NG-6. When the volume ratio (%) of catalyst particles is 2.5%, an inflection point occurs, and the performance deterioration rate (mV/1000 cycles) is made stable at low values as shown by Nos. G-4, G-5, G-6, and G-7 in FIG. 5.

These results confirmed that when a fuel cell includes an anode electrode catalyst layer in which the volume ratio of catalyst particles with a particle size of less than 1 μm is 2.5% or more of the volume of all catalyst particles contained in the anode electrode catalyst layer, the performance deterioration rate (mV/1000 cycles) is stably decreased. That is, it was confirmed that the durability of the anode electrode catalyst layer is further improved.

According to the embodiment of the present invention, a fuel cell membrane electrode assembly includes a polymer electrolyte membrane sandwiched between electrode catalyst layers of an anode and a cathode. In the membrane electrode assembly, the ratio of pore volume occupied by pores with a pore size of 0.1 μm or less is 70% or more of the pore volume occupied by pores with a pore size of 3 μm or less which are formed in the electrode catalyst layer of the anode.

In the fuel cell membrane electrode assembly, the ratio of pore volume occupied by pores with a pore size of 0.1 μm or less is 70% or more of the pore volume occupied by pores with a pore size of 3 μm or less, thereby suppressing the entrance of air (oxygen) into the electrode catalyst layer of the anode. As a result, in the fuel cell membrane electrode assembly, a corrosion current circuit is prevented from being formed between the anode and the cathode during restarting of a fuel cell. Therefore, in the fuel cell membrane electrode assembly, durability can be improved.

In addition, in the fuel cell membrane electrode assembly, the ratio of pore volume occupied by pores with a pore size of 3 μm or less which are formed in the electrode catalyst layer of the anode is preferably 2.0 μL/mm² or less.

In the fuel cell membrane electrode assembly, the ratio of pore volume occupied by pores with a pore size of 3 μm or less which are formed in the electrode catalyst layer of the anode is 2.0 μL/mm² or less, thereby more securely suppressing the entrance of air (oxygen) into the electrode catalyst layer of the anode. Therefore, in the fuel cell membrane electrode assembly, durability can be more securely improved.

According to the embodiment of the present invention, a fuel cell membrane electrode assembly includes a polymer electrolyte membrane sandwiched between electrode catalyst layers of an anode and a cathode. The volume ratio of catalyst particles with a particle size of less than 1 μm which are contained in the electrode catalyst layer of the anode is 2.5% or more of the volume of all catalyst particles contained in the electrode catalyst layer of the anode.

In the fuel cell membrane electrode assembly, the volume ratio of the catalyst particles with a particle size of less than 1 μm contained in the electrode catalyst layer of the anode is 2.5% or more of the volume of all catalyst particles contained in the electrode catalyst layer, and thus a large number of pores with a pore size or 0.1 μm or less are formed in the electrode catalyst layer. That is, the entrance of air (oxygen) into the electrode catalyst layer of the anode is suppressed. As a result, in the fuel cell membrane electrode assembly, a corrosion current circuit is prevented from being formed between the anode and the cathode during restarting of a fuel cell. Therefore, in the fuel cell membrane electrode assembly, durability can be improved.

According to the embodiment of the present invention, a method for producing a fuel cell membrane electrode assembly includes a first step of preparing a composition for forming an electrode catalyst layer of an anode by mixing at least catalyst particles and an ion conductive material, a second step of forming an electrode sheet by applying the composition for forming an electrode catalyst layer, and a third step of forming an electrode catalyst layer of an anode by disposing the electrode sheet on a surface of a polymer electrolyte membrane. The method further includes, before the first step, a step of grinding the catalyst particles.

According to the production method, the ratio of fine catalyst particles in the composition for forming an electrode catalyst layer is increased. That is, in the electrode catalyst layer, a large number of pores with a pore size of 0.1 μm or less are formed, thereby suppressing the entrance of air (oxygen) in the electrode catalyst layer of the anode. As a result, in a fuel cell including the fuel cell membrane electrode assembly produced by the production method, the formation of a corrosion current circuit between an anode and a cathode is prevented during restarting. Therefore, according to the production method, a fuel cell membrane electrode assembly having excellent durability can be produced.

According to the embodiment of the present invention, a method for producing a fuel cell membrane electrode assembly includes a first step of preparing a composition for forming an electrode catalyst layer of an anode by mixing at least catalyst particles and an ion conductive material, a second step of forming an electrode sheet by spreading the composition for forming an electrode catalyst layer, and a third step of forming an electrode catalyst layer of an anode by disposing the electrode sheet on a surface of a polymer electrolyte membrane. The method further includes, before the first step, a step of adding second catalyst particles to the prepared first catalyst particles, the second catalyst particles being produced as undersize catalyst particles by sieving catalyst particles which are separately prepared, so that a volume ratio of catalyst particles with a particle size of less than 1 μm is 2.5% or more of the volume of all catalyst particles contained in the electrode catalyst layer.

According to the production method, the electrode catalyst layer of the anode containing a large number of pores with a pore size of 0.1 μm or less can be formed. That is, the entrance of air (oxygen) in the electrode catalyst layer of the anode is suppressed. As a result, in a fuel cell including the fuel cell membrane electrode assembly produced by the production method, the formation of a corrosion current circuit between an anode and a cathode is prevented during restarting. Therefore, according to the production method, a fuel cell membrane electrode assembly having excellent durability can be produced.

According to the embodiment of the present invention, it is possible to provide a fuel cell membrane electrode assembly with durability improved by preventing deterioration of an anode electrode catalyst layer during restarting of a fuel cell and a method for producing the assembly.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell membrane electrode assembly comprising:
an anode electrode catalyst layer, a ratio of a pore volume occupied by pores with a pore size of 0.1 μm or less being 70% or more in a pore volume occupied by pores with a pore size of 3 μm or less formed in the anode electrode catalyst layer;
a cathode electrode catalyst layer; and
a polymer electrolyte membrane sandwiched between the anode electrode catalyst layer and the cathode electrode catalyst layer.

2. The fuel cell membrane electrode assembly according to claim 1, wherein the pore volume occupied by pores with a pore size of 3 μm or less formed in the anode electrode catalyst layer is 2.0 μL/mm³ or less.

3. A fuel cell membrane electrode assembly comprising:
an anode electrode catalyst layer, a volume ratio of catalyst particles with a particle size of less than 1 μm contained in the anode electrode catalyst layer being 2.5% or more of a volume of all catalyst particles contained in the anode electrode catalyst layer;
a cathode electrode catalyst layer; and
a polymer electrolyte membrane sandwiched between the anode electrode catalyst layers and the cathode electrode catalyst layer.

4. A method for producing a fuel cell membrane electrode assembly comprising:
mixing at least catalyst particles and an ion conductive material to prepare a composition to form an anode electrode catalyst layer;
applying the composition to form an electrode catalyst layer on a substrate to form an electrode sheet; and
disposing the electrode sheet on a surface of a polymer electrolyte membrane to form an anode electrode catalyst layer,
wherein the method further comprises, before the mixing step, grinding the catalyst particles.

5. A method for producing a fuel cell membrane electrode assembly comprising:
mixing at least catalyst particles and an ion conductive material to prepare a composition to form an anode electrode catalyst layer;
spreading the composition to form an electrode catalyst layer on a substrate to form an electrode sheet; and
disposing the electrode sheet on a surface of a polymer electrolyte membrane to form an anode electrode catalyst layer,
wherein the method further comprises, before the mixing step, adding second catalyst particles to prepared first catalyst particles, the second catalyst particles being produced as undersize catalyst particles by sieving catalyst particles separately prepared, so that a volume ratio of catalyst particles with a particle size of less than 1 μm is 2.5% or more of a volume of all catalyst particles contained in the electrode catalyst layer.
